(19) United States
(12) Patent Application Publication
(10) Pub. No.: US 2005/0135604 A1
(43) Pub. Date: Jun. 23, 2005

(54) Technique for generating output states in a security algorithm

(76) Inventors: Wajdi K. Feghali, Boston, MA (US); Gilbert M. Wolrich, Framingham, MA (US); Matthew J. Adiletta, Worcester, MA (US); Brad A. Burres, Cambridge, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/745,238

(22) Filed: Dec. 22, 2003

(51) Int. Cl. H04L 9/00; G06F 7/38

(52) U.S. Cl. 380/28; 708/491

(57) ABSTRACT

An architecture to perform a hash algorithm. Embodiments of the invention relate to the use of processor architecture logic to implement an addition operation of initial state information to intermediate state information as required by hash algorithms while reducing the contribution of the addition operation to the critical path of the algorithm's performance within the processor architecture.

### FIELD

Embodiments of the invention relate to network security algorithms. More particularly, embodiments of the invention relate to the performance of the secure hash algorithm 1 (SHA-1) security algorithm within network processor architectures.

### BACKGROUND

Security algorithms may be used to encode or decode data transmitted or received in a computer network through techniques, such as compression.

In some instances, the network processor may compress or decompress the data in order to help secure the integrity and/or privacy of the information being transmitted or received within the data. The data can be compressed or decompressed by performing a variety of different algorithms, such as hash algorithms.

One such hash algorithm is the secure hash algorithm 1 (SHA-1) security algorithm. The SHA-1 algorithm can be a laborious and resource-consuming task for many network processors, however, as it requires numerous mathematically intensive computations within a main recursive compression loop. Moreover, the main compression loop may be performed numerous times in order to compress or decompress a particular amount of data.

In general, hash algorithms are algorithms that take a large group of data and reduce it to a smaller representation of that data. Hash algorithms may be used in such applications as security algorithms to protect data from corruption or detection. The SHA-1, for example, may reduce groups of 64 bytes of data to 20 bytes of data. Other hash algorithms, such as the SHA 128, 129, and message digest 5 (MD5) algorithm may also be used to reduce large groups of data to smaller ones. Hash algorithms, in general, can be very taxing on computer system performance, as the algorithm requires intensive mathematical computations in a recursive main compression loop that is performed iteratively to compress or decompress groups of data.

Adding to the difficulty in performing the hash algorithms at high frequencies are the latencies, or “bottlenecks” that can occur between operations of the algorithm due to data dependencies between the operations. When performing the algorithm on typical processor architectures, the operations must be performed in substantially sequential fashion because typical processor architectures perform the operations of each iteration of the main compression loop on the same logic units or group of logic units. As a result, if dependencies exist between the iterations of the main loop, a bottleneck forms while unexecuted iterations are delayed to allow the hardware to finish processing the earlier operations.

These bottlenecks can be somewhat abrogated by taking advantage of instruction-level parallelism (ILP) of instructions within the algorithm and performing them in parallel execution units.

Typical prior art parallel execution unit architectures used to perform hash algorithms have had marginal success. This is true, in part, because the instruction and sub-instruction operations associated with typical hash algorithms rarely have the necessary ILP to allow true independent parallel execution. Furthermore, earlier architectures do not typically schedule operations in such a way as to minimize the critical path associated with long dependency chains among various operations.

FIG. 1 illustrates a prior art dedicated logic circuit for performing the addition of the input state data to the intermediate output state data required by the SHA-1 algorithm. The prior art adder circuit of FIG. 1 consists of carry-store adder (CSA) and a full adder. Inputs to the adder circuit are stored in registers C, D, and E. Registers C and D also store the carry bits as well as store the previous CSA result. Register E stores the carry and sum bits, which are rotated left by 5 bits and fed back to the input stage as well as the output of the adder to be provided to the next stage of the pipeline.

The adder circuit of FIG. 1 can contribute to the critical path of the SHA-1 algorithm due to the fact that the same adders must handle both the sum and the carry information, thereby placing a higher workload on the adders. Furthermore, the use of dedicated adder circuits to perform the addition of the input state to the intermediate output state is costly if the addition could be performed faster using logic that already exists in the datapath to perform other aspects of the SHA-1 algorithm.

### BRIEF DESCRIPTION OF THE DRAWINGS

Embodiments of the invention are illustrated by way of example and not limitation in the figures of the accompanying drawings, in which like references indicate similar elements and in which:

FIG. 1 illustrates a prior art technique for performing the addition of the input state and the intermediate output state as required by the SHA-1 algorithm.

FIG. 2 illustrates a portion of a pipelined processor architecture that may be used to perform the SHA-1 algorithm according to one embodiment of the invention.

FIG. 3 is a flow diagram illustrating operations within a hash algorithm according to one embodiment of the invention.

FIG. 4 illustrates a portion of a pipeline architecture used to implement the SHA-1 algorithm which includes an improved adder circuit according to one embodiment of the invention.

FIG. 5 illustrates a network processor architecture in which one embodiment of the invention may be used.

FIG. 6 illustrates a computer system in which at least one embodiment of the invention may be implemented.

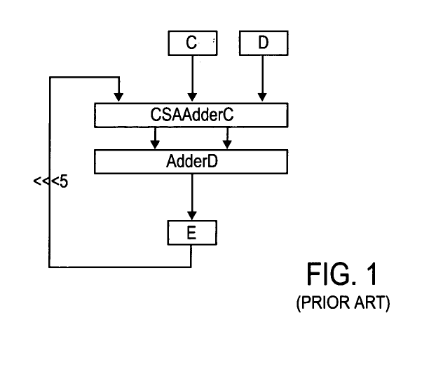

### DETAILED DESCRIPTION

Embodiments of the invention relate to processor architecture for performing the hash algorithm, such as a secure hash algorithm 1 (SHA-1). More particularly, embodiments of the invention relate to the use of processor architecture logic to implement an addition operation of initial state information to intermediate state information as required by hash algorithms while reducing the contribution of the addition operation to the critical path of the algorithm's performance within the processor architecture.

Disclosed herein is at least one embodiment of the invention to perform at least a portion of a hash algorithm by using available logic within a semiconductor device, such as a processor, to perform an addition operation between a hash algorithm input and an intermediate output to produce a final output state of the hash algorithm. Also disclosed herein is at least one embodiment of the invention that may be used to perform at least a portion of a hash algorithm by using additional or available logic to perform an intermediate addition operation via separate parallel addition operations.

In at least one embodiment of the invention, intermediate output states of a hash algorithm can be performed more efficiently than prior art implementations by using logic available in the hash algorithm pipeline architecture, rather than resorting to logic within a control and data path outside of the hash algorithm pipeline. For example, in one embodiment of the invention, intermediate addition operations of the SHA-1 algorithm are performed within the SHA-1 pipeline data path and control logic.

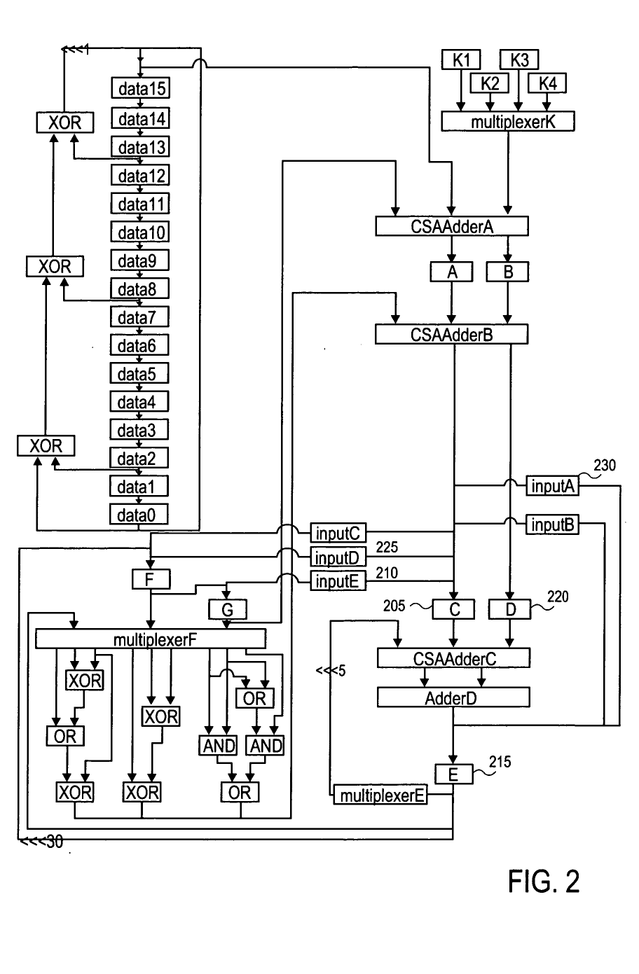

FIG. 2 is a hash algorithm pipeline that may be used to generate intermediate output states in one embodiment of the invention. In one pipeline cycle of the architecture illustrated in FIG. 2, register C 205 is loaded with input state E 210 and register D 220 will have the intermediate output state of data D. In the next cycle, register E 215 will contain the final output state of E. In the next cycle of the pipeline, register C is loaded with the input state D 225 and register D will have the intermediate output state of D. In the following pipeline cycle, register E will have the final output state of D.

The above operations may continue for each input state of the pipeline of FIG. 2 to generate each intermediate output state. In the pipeline architecture illustrated in FIG. 2, input state A 230 may enter register C sometime after input state D, and register D contains the intermediate output state of A. In the following cycle of the pipeline, register E will have the final output of state A. The intermediate outputs generated in the embodiments of the invention illustrated in FIG. 2 may all be performed within the hash algorithm pipeline data path and control logic, without resorting to circuitry lying outside the hash algorithm pipeline.

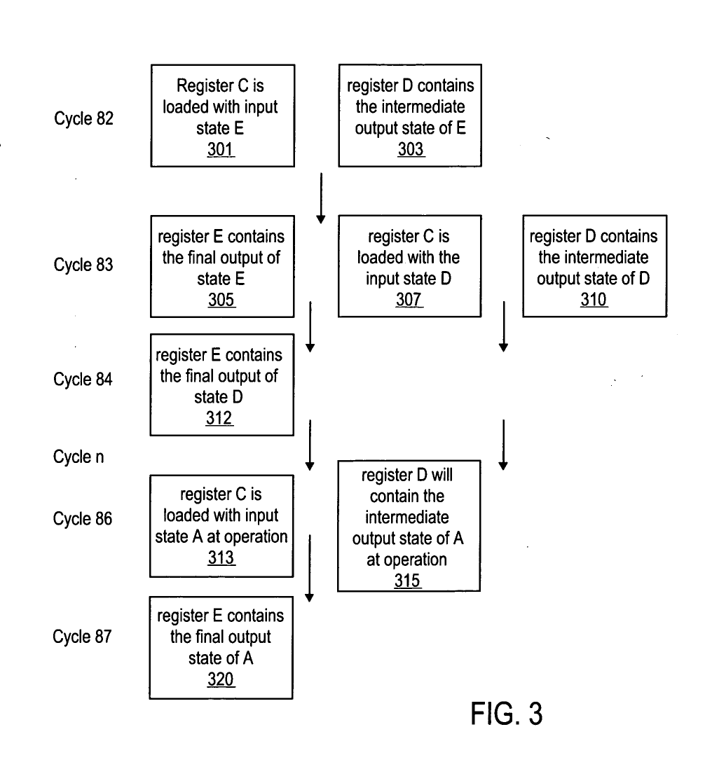

In one embodiment of the invention, the hash algorithm is a SHA-1 algorithm. FIG. 3 is a flow diagram illustrating operations associated with the SHA-1 algorithm that may be performed using at least one embodiment of the invention. Specifically, the operations illustrated in FIG. 3, may be used in conjunction with the architecture illustrated in FIG. 2 to perform the SHA-1 algorithm in one embodiment of the invention. Although FIG. 3 illustrates pipeline cycles 83, 84, 86, and 87 associated with one implementation of the SHA-1 algorithm, embodiments of the invention are not so limited. For example, the operations illustrates in FIG. 3 may be applied to other cycles of the SHA-1 algorithm or to other cycles of other hash algorithms involving the generation of an intermediate output state.

In cycle 82 of the pipeline illustrated in FIG. 2, register C is loaded with input state E at operation 301 and register D contains the intermediate output state of E at operation 303. In cycle 83 of the pipeline, register E will contain the final output of state E at operation 305. In cycle 83 of the pipeline, register C is loaded with the input state D at operation 307 and register D will contain the intermediate output state of D at operation 310. Register E will contain the final output state of D at operation 312.

The above operations may continue for, as many input states are available to the pipeline. For example, in cycle 86, register C is loaded with input state A at operation 313 and register D will contain the intermediate output state of A at operation 315, whereas at state 87 register E will contain the final output state of A at operation 320.

In at least one embodiment of the invention, the critical path of the hash algorithm pipeline of FIG. 2 is reduced by splitting the addition operation involved in generating the intermediate output state between two parallel addition operations. For example, the SHA-1 algorithm typically involves a left rotate of 5 bits of the previously computed chaining variable, which are recombined in subsequent logic in the pipeline. In one embodiment of the invention, the critical path of the pipeline of FIG. 2 may be reduced by splitting the 32-bit chaining variables into a 5-bit portion and a 27-bit portion and using carry-select adders to perform the addition operations in parallel.

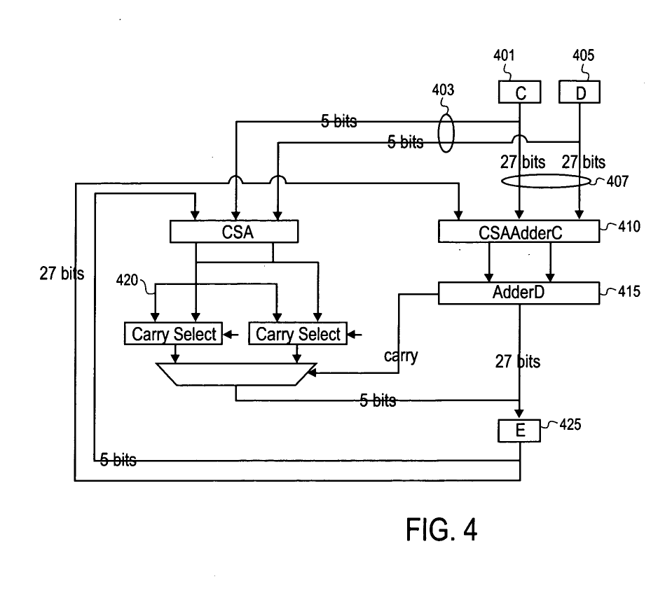

FIG. 4 illustrates one embodiment of the invention in which inputs C 401 and D 405 are split into a 5-bit portion 403 and a 27-bit portion 407. The 27-bit portion is sent through the carry select adder 410 and full adder 415, and the 5-bit portion is sent through the carry select adder 420, the result from which is recombined with the 27-bit adder result in register E 425. One result of splitting the addition operation of the 32-bit numbers in registers C and D is to reduce the critical path of the pipeline of FIG. 2 while incurring only a slight increase in architecture complexity and area.

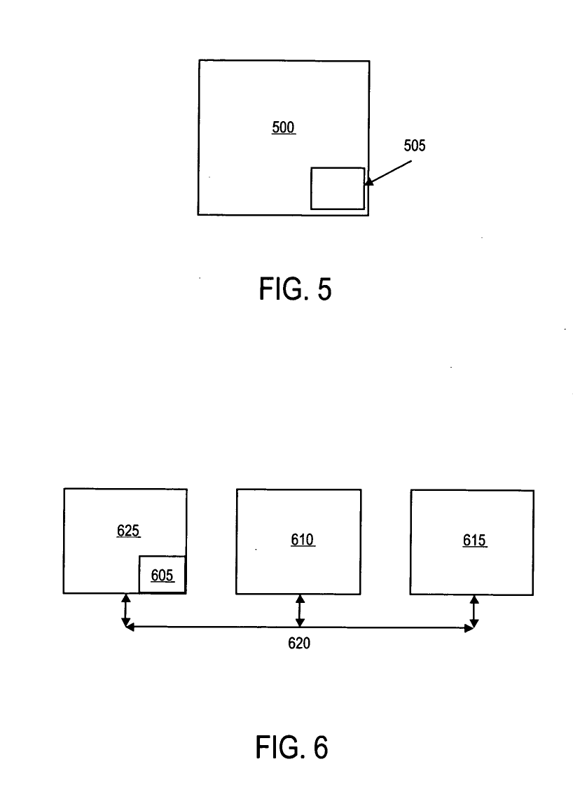

FIG. 5 illustrates a processor architecture in which one embodiment of the invention may be used to perform a hash algorithm while reducing performance degradation, or “bottlenecks”, within the processor. In the embodiment of the invention illustrated in FIG. 5, the pipeline architecture of the encryption portion 505 of the network processor 500 may operate at frequencies at or near the operating frequency of the network processor itself or, alternatively, at an operating frequency equal to that of one or more logic circuits within the network processor.

FIG. 6 illustrates a computer network in which an embodiment of the invention may be used. The host computer 625 may communicate with a client computer 610 or another host computer 615 by driving or receiving data upon the bus 620. The data is received and transmitted across a network by a program running on a network processor embedded within the network computers. At least one embodiment of the invention 605 may be implemented within the host computer in order to compress that data that is sent to the client computer(s).

Embodiments of the invention may be performed using logic consisting of standard complimentary metal-oxide-semiconductor (CMOS) devices (hardware) or by using instructions (software) stored upon a machine-readable medium, which when executed by a machine, such as a processor, cause the machine to perform a method to carry out the steps of an embodiment of the invention. Alternatively, a combination of hardware and software may be used to carry out embodiments of the invention.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

1. An apparatus comprising:
a datapath in which to perform a portion of a hash algorithm, the datapath including a first logic unit to add input state data of the SHA-1 algorithm to intermediate output state data and a second logic unit to add carry data corresponding to the addition of the input state data and intermediate output state data in parallel with the first logic unit.

2. The apparatus of claim 1 wherein the input state data and intermediate output state data are split into a first input bit group of a first size to be operated upon by the first logic circuit and a second input bit group of a second bit size to be operated upon by the second logic unit.

3. The apparatus of claim 2 wherein each of the first logic unit and the second logic unit comprises a carry select adder.

4. The apparatus of claim 3 wherein carry information is provided from the first logic unit to the second logic unit to select a bit group of the second bit size to be combined with output data from the first logic unit of the first bit size in order to generate a final output state data.

5. The apparatus of claim 4 wherein the output of the first logic unit is coupled to the input of the second logic unit so as to allow a second output bit group of the second bit size to be fed back to the input of the second logic unit.

6. The apparatus of claim 5 wherein the output of the first logic unit is coupled to the input of the first logic unit so as to allow a first output group of the first data size to be fed back to the input of the first logic unit.

7. The apparatus of claim 6 wherein the first data size is 27 bits, the second data size is 5 bits, and the size of the final output state data is 32 bits.

8. The apparatus of claim 1 wherein the datapath is the same datapath used to perform a main compression loop of the hash algorithm.

9. A processor comprising:
a plurality of pipeline stages in which to perform a plurality of iterations of a compression loop of a hash algorithm, the plurality of pipeline stages including an adder unit in which to add initial state data to intermediate state data to generate output state data.

10. The processor of claim 9 wherein the adder circuit includes a first logic unit to add the initial state data to the intermediate output state data and a second logic unit to add carry data corresponding to the addition of the initial state data and intermediate state data in parallel with the first logic unit.

11. The processor of claim 10 wherein the initial state data and intermediate state data are split into a first input bit group of a first size to be operated upon by the first logic circuit and a second input bit group of a second bit size to be operated upon by the second logic unit.

12. The processor of claim 11 wherein each of the first logic unit and the second logic unit comprises a carry select adder.

13. The processor of claim 12 wherein carry information is coupled from the first logic unit to the second logic unit to select a bit group of the second bit size to be combined with output data from the first logic unit of the first bit size in order to generate the output state data.

14. The processor of claim 13 wherein the output of the first logic unit is coupled to the input of the second logic unit so as to allow a second output bit group of the second bit size to be fed back to the input of the second logic unit.

15. The processor of claim 14 wherein the output of the first logic unit is coupled to the input of the first logic unit so as to allow a first output group of the first data size to be fed back to the input of the first logic unit.

16. The processor of claim 15 wherein the first data size is 27 bits, the second data size is 5 bits, and the size of the output state data is 32 bits.

17. A system comprising:
a network processor, the network processor comprising a datapath in which a pipeline is used to perform a compression loop of a secure hash algorithm 1 (SHA-1) algorithm and to add an initial state value associated with the SHA-1 algorithm with an intermediate state value generated by performing the SHA-1 algorithm;
a memory unit to store instructions, which when performed by the network processor, cause the compression loop to be performed within the pipeline.

18. The system of claim 17 wherein the memory is to store the initial state value and the intermediate state value.

19. The system of claim 17 wherein the pipeline comprises an adder unit to add the initial state value to the intermediate state value.

20. The system claim 19 adder unit includes a first logic unit to add the initial state data to the intermediate output state data and a second logic unit to add carry data corresponding to the addition of the initial state value and intermediate state value in parallel with the first logic unit.

21. A method comprising:
storing a first data element having a first input state in a first storage element and storing an intermediate output state of the first data element in a second storage element within the same processing cycle period;
storing a final output state of the first data element in a third storage element, storing a second data element in the first storage element, and storing an intermediate output state of the second data element in the second storage element within the same processing cycle period.

22. The method of claim 21 further comprising storing a final output state of the second data element in the third storage register in a processing cycle period.

23. The method of claim 22 wherein the processing cycles include cycle 82, 83, and 84 of a hash algorithm.
